(19) United States
(12) Patent Application Publication
(10) Pub. No.: US 2009/0283463 A1
(43) Pub. Date: Nov. 19, 2009

(54) Strainer with omega type screen

(75) Inventor: Jeong Yeol Kim, Suwon-Si (KR)

Correspondence Address: GWIPS;Peter T. Kwon, Gwacheon P.O. Box 72, 119 Byeolyang Ro, Gwacheon City, Gyeonggi-Do, 427-600, KR

(73) Assignee: Eui Ho Lee

(21) Appl. No.: 12/222,397

(22) Filed: Aug. 8, 2008

(30) Foreign Application Priority Data
May 13, 2008 (KR) 2008-0043948

(51) Int. Cl. B01D 35/28

(52) U.S. Cl. 210/162; 210/447

(57) ABSTRACT

A strainer is developed for mounting in a fluid system or a pipeline to filter the foreign objects remained in the fluid, thereby preventing malfunctioned operation, default and occlusion of the fluid machinery and the pipeline due to floating and drifting solids, and which includes an inlet and an outlet formed in a straight line and an omega-type screen joined to a cylindrical main body having a closed lower portion, thereby minimizing a transformation of a flow channel while maximally providing a screening face, and allowing a user to easily disassemble and clean the screen. The strainer can raise operational efficiencies of the fluid machine and the pipeline and remarkably reduce operational expenses by minimizing energy loss in the fluid, and reduce maintenance cost and ensure durability of the fluid machine and the pipeline by ensuring convenience in cleaning and maintaining the screen of the strainer.

### BACKGROUND OF THE INVENTION

1. Field of the Invention

The present invention relates to a strainer, which is mounted in a fluid machine or a pipeline to screen the fluid and collect solid foreign substances remaining in the fluid, thereby preventing erroneous operation, default and occlusion of the fluid machine and the pipeline due to floating and drifting solids, and more particularly, to a strainer, which includes an inlet and an outlet formed in a straight line and an omega-type screen joined to a cylindrical main body having a closed lower portion, thereby minimizing a transformation of a flow channel while maximally securing a screening face, and allowing a user to easily disassemble and clean the screen.

2. Background Art

A strainer is an essential accessory used in most of fluid machines and pipelines, and basically includes a screen for screening a fluid and a main body for supporting the screen and inducing the fluid to pass through the screen along a predetermined flow channel. The strainer is divided into various types such as a U-type, a Y type and the like according to the shape of the main body and the screen. Foreign substances gathered and deposited on the screen are periodically removed to thereby maintain a smooth flow of the fluid.

The strainer maintains a clean state of the fluid flowing in the fluid machine and the pipeline to prevent erroneous operation and default of various accessories and to maintain a good fluid-transporting capability of the fluid machine and the pipeline. However, the conventional strainer has several problems in that the main body itself may contribute to a loss of energy in terms of hydrodynamics, for instance, expansion, reduction, flexure and the like of a pipe body, and in that the screen may cause an obstruction in the entire flow of the fluid since the cross section of the flow channel is inevitably reduced.

Particularly, the conventional strainer has further problems in that it may cause a severe loss of energy in the entire fluid flow when the degree of occlusion of a mesh is increased since an unreasonable process in maintenance, such as disassembly and cleaning of the screen, may cause said maintenance to be neglected; and in that it may cause fatal defects on the fluid machine and the pipeline by arousing unwanted eddy currents and incurring excessive pressure differential between the front and rear points of the strainer.

FIG. 1 is a representative sectional view of a conventional strainer, in which a U-shaped strainer and a Y-shaped strainer now widely used are respectively shown in the left side and the right side.

In FIG. 1, the U-shaped strainer (on the left side) has a screen 200 of a U-shaped longitudinal section. In the U-shaped strainer, when fluid introduced into the screen 200 is discharged through the screen 200, solid-type foreign substances are gathered on the inner peripheral surface and the bottom surface of the screen 200.

The screen 200 can be easily disassembled from the U-shaped strainer when a cover 190 located on an upper portion is removed, but it is not easy to clean in that a face where the foreign substances are gathered is not exposed and one end of the screen 200 is closed, and in that it causes a severe transformation of the flow channel during introduction and discharge processes of the fluid into and from the screen 200.

In FIG. 1, the Y-shaped strainer of the right side has a Y-shaped main body 100 and a cylindrical screen 200 located in the main body 100. While fluid introduced into the cylindrical screen 200 is discharged through the screen 200, solid type foreign substances are gathered on the inner peripheral surface of the screen 200.

The Y-shaped strainer causes relatively less transformation of the flow channel than the U-shaped strainer. However, the Y-shaped strainer also has several problems in that it does cause a transformation of the flow channel, and in that it is difficult to disassemble and clean the screen 200 since the a face where the foreign substances are gathered and deposited is not exposed like the screen 200 of the U-shaped strainer.

### SUMMARY OF THE INVENTION

Accordingly, the present invention has been made in view of the above-mentioned problems occurring in the prior arts, and it is an object of the present invention to provide a strainer with an omega-type screen which can prevent erroneous operation, default and occlusion of a fluid machine and a pipeline due to floating and drifting solids, and which can minimize a transformation of a flow channel while maximally providing a screening face. and allow a user to easily disassemble and clean the screen.

To accomplish the above object, according to the present invention, there is provided a strainer with an omega-type screen comprising: a cylindrical main body having an inlet and an outlet respectively formed at both sides thereof, the main body having a closed lower portion; a screen joined to the inside of the main body and having an omega (Ω)-shaped plane cross section in which both ends of an arc having a reflex angle are bent outward, the screen having an opening portion formed between both ends of the arc in such a way as to be oriented toward the inlet; and a cover mounted on an upper portion of the main body to close the upper end of the main body. The main body comprises a projection formed on an inner peripheral surface of the outlet in such a way as to coincide with an outer peripheral surface of the screen, such that a central line of the screen is spaced apart from a central line of the main body at a predetermined interval toward the inlet. Moreover, the screen comprises a bottom plate mounted on a lower end thereof.

### BRIEF DESCRIPTION OF THE DRAWINGS

FIG. 1 is a sectional view of a conventional strainer;

FIG. 2 is an exploded perspective view of a strainer according to the present invention;

FIG. 3 is an exploded perspective view in a partial section, showing essential parts of the strainer according to the present invention;

FIG. 4 is a sectional view showing an operational state of the strainer according to the present invention;

FIG. 5 is a perspective view of a screen of the strainer according to the present invention; and

FIG. 6 is a perspective view of the screen, which has a bottom plate.

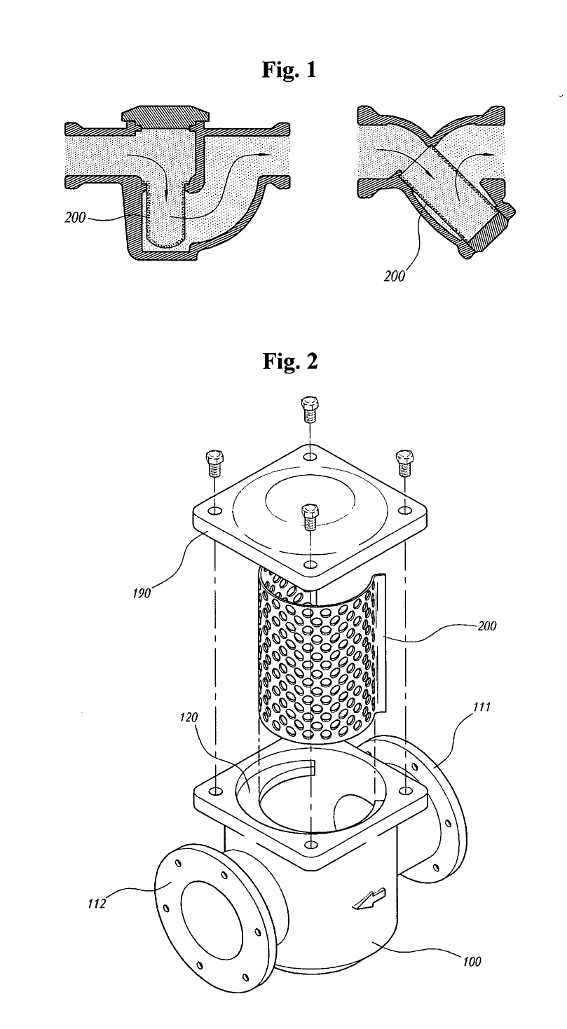

### DETAILED DESCRIPTION OF THE PREFERRED EMBODIMENT

Reference will be now made in detail to the preferred embodiment of the present invention with reference to the attached drawings.

FIG. 2 is an exploded perspective view showing components of a strainer according to the present invention. As shown in FIG. 2, the strainer includes: a cylindrical main body 100 having an outlet 112 formed on a front face thereof and an inlet 111 formed on a rear face thereof, the main body 100 having a closed lower portion, a screen 200 joined to the inside of the main body 100; and a cover 190 for closing an upper portion of the main body 100.

While water stops (not shown), such as packings, for ensuring watertightness may be joined to a bottom of the cover 190, an upper end of the main body 100, pipe connection portions of the inlet 111 and the outlet 112, and so on, they are not restricted in claims in detail since those skilled in the art can properly apply them as occasion demands.

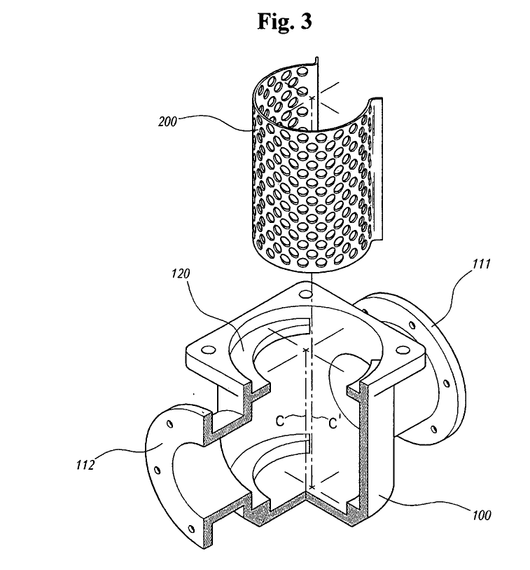

As shown in FIG. 3, the screen 200 according to the present invention has an omega (Ω) type section, namely, a section that both end portions of an arc, which has a reflex angle starting from a straight angle, are bent outwardly, and an opening portion between the both end portions is joined to the main body 100 in such a way as to be located on the inlet 111.

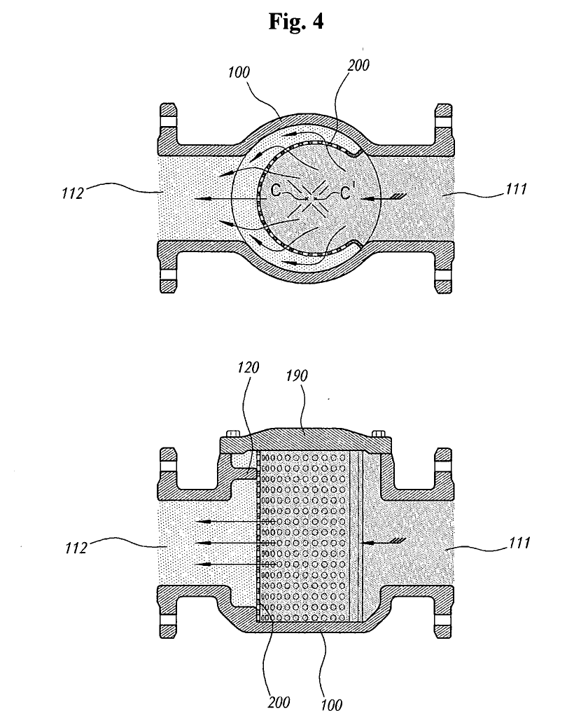

That is, as shown in FIG. 4, the fluid introduced into the inlet 111 is discharged to the outlet 112 through the screen 200 after being introduced to the inside of the arc through the opening between both end portions. As you can see from FIG. 4, a flow channel of the fluid extending from the inlet 111 to the outlet 112 is hardly transformed, and a central line of the flow channel is in a straight line.

In the meantime, as shown in FIG. 3, the main body 100 has a projection 120 formed on an inner peripheral surface of the outlet 112 in such a way as to coincide with an outer peripheral surface of the screen 200, such that a central line (c′) of the screen 200 is separated from a central line (c) of the main body 100 at a predetermined interval toward the inlet 111. Accordingly, as shown in the upper part of FIG. 4, in relation with a fluid flow in a space between the inner peripheral surface of the main body 100 and the outer peripheral surface of the screen 200, a flow cross section ranging from an end portion of an arc where a fluid flow rate is relatively small to a central point of an arc where the fluid flow rate is relatively large is gradually increased, whereby the fluid can flow more smoothly.

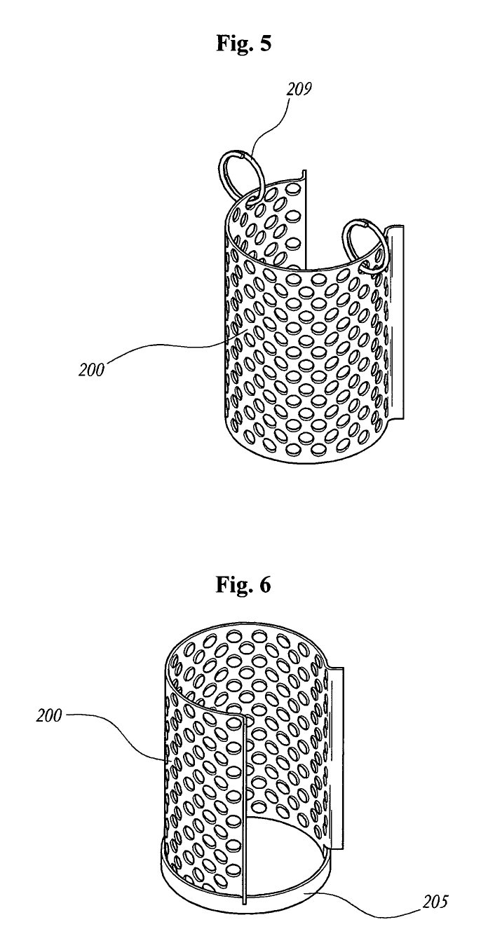

As shown in FIGS. 2 and 3, the screen 200 according to the present invention can be simply removed when it is pulled upward after the cover 190 positioned on the upper end of the main body 100 is removed. The screen 200 is very easy to maintain and clean, and can be more simply removed when a ring 209 is joined to the upper end thereof as shown in FIG. 5.

Particularly, the screen 200 has a completely opened inner peripheral surface, on which the solid type foreign substances are gathered and deposited, and hence, is very easy to clean and provide an excellent back wash effect in comparison with screens of conventional strainers.

In the meantime, FIG. 6 illustrates another embodiment in which a bottom plate 205 having the same shape as a lower end of the screen 200 is attached to the lower end of the screen 200. The bottom plate 205 is fixed to the lower end portion of the screen 200 to prevent a transformation of the screen 200 and to collect the solid type foreign substances when the solid type foreign substances deposited on the inner peripheral surface of the screen 200 are separated from the inner peripheral surface of the screen 200, or floating foreign substances in the fluid are deposited inside the main body 100. The bottom plate 205 can be removed together with the screen 200 when the screen 200 is cleaned.

As described above, the strainer according to the present invention can raise operational efficiencies of the fluid machine and the pipeline and remarkably reduce operational expenses by minimizing an energy loss of the fluid, and reduce maintenance cost and ensure durability of the fluid machine and the pipeline by providing convenience in cleaning and maintaining the screen of the strainer.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A strainer with an omega-type screen comprising:
a cylindrical main body (100) having an inlet (111) and an outlet (112) respectively formed at both sides thereof, the main body (100) having a closed lower portion;
a screen (200) joined to the inside of the main body (100) and having an omega (Ω)-shaped plane cross section in that both ends of an arc having a reflex angle are bent outward, the screen (200) having an opening portion formed between the ends of the arc in such a way as to be oriented toward the inlet (111); and
a cover (190) mounted on an upper portion of the main body (100) to close the upper end of the main body (100).

2. The strainer according to claim 1, wherein the main body (100) comprises a projection (120) formed on an inner peripheral surface of the outlet (112) so as to coincide with an outer peripheral surface of the screen (200), such that a central line (c′) of the screen (200) is separated from a central line (c) of the main body (100) at a predetermined interval toward the inlet (111).

3. The strainer according to claim 1, wherein the screen (200) comprises a bottom plate (205) mounted on a lower end thereof.
